(19) United States
(12) Patent Application Publication
(10) Pub. No.: US 2018/0172037 A1
(43) Pub. Date: Jun. 21, 2018

(54) SYSTEM AND METHOD FOR PROVIDING HYDRAULIC POWER

(71) Applicant: Caterpillar Global Mining LLC, Oak Creek, WI (US)

(72) Inventors: Sharath CUGATI, Dortmund (DE); Christoper WILLIAMSON, AMES, IA (US); Pengfei MA, Naperville, IL (US); Mark VONDERWELL, Franklin, WI (US); Sean JOHNSON, Ratingen (DE); James W. FUERST, Wauwatosa, WI (US); Jiao ZHANG, Naperville, IL (US)

(21) Appl. No.: 15/384,423

(22) Filed: Dec. 20, 2016

(51) Int. Cl. F15B 21/08; F15B 11/17; F15B 11/16; E02F 9/22; E02F 3/42

(52) U.S. Cl. CPC F15B 21/08; F15B 11/17; F15B 11/165; E02F 3/308; E02F 9/2228; E02F 3/425; F15B 2211/41509; E02F 9/2292

(57) ABSTRACT

A hydraulic system for a machine includes a plurality of hydraulic component, wherein the hydraulic components include hydraulic actuators and hydraulic motors. The hydraulic system also includes a plurality of hydraulic circuits, and a plurality of hydraulic pumps for supplying hydraulic fluid to the plurality of hydraulic components via the hydraulic circuits. At least one hydraulic component receives hydraulic flow exclusively from a designated one of the hydraulic pumps and at least another, different hydraulic component receives shared hydraulic flow from a flow sharing set of the hydraulic pumps.

### TECHNICAL FIELD

The present disclosure relates generally to a strategy for providing hydraulic power through a plurality of hydraulic circuits of a machine.

### BACKGROUND

Fuel is a major portion of the total cost of ownership for a number of hydraulic machines, such as, for example, hydraulic mining excavators or shovels. As such, hydraulic systems with greater efficiency may offer a competitive advantage. Typically, however, these systems are not optimized for energy efficiency. For example, on some hydraulic mining shovels, there are four main pumps. One pump powers clam cylinders, while travel motors are powered by one pump for each side of the machine. Yet, regardless of the work cycle segment being performed, when an operator actuates the pedal for propulsion, all four pumps get the same command and, typically, this results in pressurized oil being provided at a much higher rate than is necessary.

European Patent Application No. EP 2746466 to Cugati et al. discloses a system and method for providing hydraulic power to a plurality of hydraulic circuits of a machine. In particular, the disclosed system allows assigning individual hydraulic pumps to different hydraulic circuits of the hydraulic system. As such, the system nearly eliminates all flow sharing between the different hydraulic circuits to avoid pressure drop losses.

As should be appreciated, there is a continuing need to provide greater energy efficiency in the area of hydraulic machinery. The present disclosure is directed to such an endeavor.

### SUMMARY OF THE INVENTION

In one aspect, a hydraulic system for a machine includes a plurality of hydraulic component, wherein the hydraulic components include hydraulic actuators and hydraulic motors. The hydraulic system also includes a plurality of hydraulic circuits, and a plurality of hydraulic pumps for supplying hydraulic fluid to the plurality of hydraulic components via the hydraulic circuits. At least one hydraulic component receives hydraulic flow exclusively from a designated one of the hydraulic pumps and at least another, different hydraulic component receives shared hydraulic flow from a flow sharing set of the hydraulic pumps.

In another aspect, a hydraulic excavator includes a machine frame supporting a hydraulic system. The hydraulic system includes a plurality of hydraulic components, wherein the hydraulic components include hydraulic actuators and hydraulic motors. The hydraulic system also includes a plurality of hydraulic circuits and a plurality of hydraulic pumps for supplying hydraulic fluid to the plurality of hydraulic components via the hydraulic circuits. An electronic controller provides independent pump control commands to each of the hydraulic pumps such that at least one hydraulic component receives hydraulic flow exclusively from a designated one of the hydraulic pumps and at least another, different hydraulic component receives shared hydraulic flow from a flow sharing set of the hydraulic pumps.

In yet another aspect, a method of controlling hydraulic flow for a hydraulic system of a machine includes a step of circulating hydraulic fluid from a plurality of hydraulic pumps to a plurality of hydraulic components, wherein the hydraulic components include hydraulic actuators and hydraulic motors, via a plurality of hydraulic circuits. The method also includes steps of providing hydraulic flow to at least one hydraulic component exclusively from a designated one of the hydraulic pumps, and providing shared hydraulic flow to at least another, different hydraulic component from a flow sharing set of the hydraulic pumps.

### BRIEF DESCRIPTION OF THE DRAWINGS

FIG. 1 is a schematic diagram of a hydraulic excavator, according to the present disclosure;

FIG. 2 is a prior art system of providing hydraulic power to a plurality of hydraulic circuits; and

FIG. 3 is a system of providing hydraulic power to a plurality of hydraulic circuits of the hydraulic excavator of FIG. 1, according to the present disclosure.

### DETAILED DESCRIPTION

An exemplary machine, according to the present disclosure, is shown generally at 10 and, as shown, may be a hydraulic excavator, such as, for example, a hydraulic mining excavator or hydraulic mining shovel. Although a hydraulic excavator is shown and described, the present disclosure is broadly applicable to a variety of dozers, loaders, motor graders, and other types of mobile or stationary machinery that utilize hydraulic systems, including hydraulic components, such as hydraulic actuators and hydraulic motors, to accomplish a variety of tasks and machine movements.

The exemplary hydraulic excavator 10 may generally include a machine frame 12 supporting at least one engine 14, such as an internal combustion engine, or other power source. As should be appreciated, the engine 14 may produce mechanical power that may be used by one or more machine systems or components, also supported on machine frame 12. For example, the engine 14 may power, among various other machine systems, a propulsion or drive system, which may include a tracked undercarriage 16 or other propulsion or traction device, for propelling the machine 10. Supported above the undercarriage 16 may be a turntable 18, as is known to those skilled in the art, which may be used to rotatably support a platform 20 including an operator control station 22, which may house various operator input devices and controls.

The machine frame 12 may also support a hydraulic system 24. According to the present disclosure, the engine 14 may produce mechanical power that may be converted to hydraulic power using the hydraulic system 24. The hydraulic system 24 may include a variety of known hydraulic components, such as, for example, tanks, valves, accumulators, actuators, motors, and other suitable components for producing and/or distributing a pressurized flow of hydraulic fluid. Hydraulic system 24 may further comprise fluid sources, for example, a reservoir or sump, and one or more hydraulic pumps, which may include variable displacement pumps, fixed displacement pumps, variable delivery pumps or other suitable pressurizing pumps or systems. The hydraulic pumps may be operationally connected to the engine 14, or may be indirectly connected to the engine 14 via a gear mechanism or the like.

The hydraulic system 24 may include a plurality of hydraulic actuators, such as, for example, a pair of hydraulic actuators 26 for operating a boom 28 of the machine 10, a pair of hydraulic actuators 30 for operating a stick 32 of the machine 10, a pair of hydraulic actuators 34 for operating a bucket 36 of the machine 10, and hydraulic actuators 38 for those machines configured with a clam bucket 40. As should be appreciated by those skilled in the art, the various actuators 26, 30, 34, and 38 may be embodied as hydraulic cylinders, including a piston and piston rod reciprocating within the piston.

The hydraulic system 24 may also include a pair of hydraulic motors 42 associated with left and right propulsion drives for the tracked undercarriage 16. It should be appreciated that, in other embodiments, different numbers and/or types of hydraulic actuators and/or hydraulic motors may be used in hydraulic system 24. Those skilled in the art should also appreciate that various alternative or additional tools or implements may be supported by the machine 10 and operated using hydraulic system 24.

Machine 10 may also utilize or include a control system or device, such as an electronic controller 46, suitable for controlling the hydraulic system 24 and other components, including, for example, the engine 14, of machine 10. The electronic controller 46 may be operatively connected to operator input devices, which may be located in the operator control station 22, and may be adapted to receive an electronic signal input from an operator input device of a desired movement, or desired velocity, of the machine 10. The electronic controller 46, in turn, may determine a power demand associated with one or more of the hydraulic actuators 26, 30, 34, and 38 and/or motors 42 of the hydraulic system 24 for performing the desired movement.

The electronic controller 46 may be of standard design and may include a processor, such as, for example, a central processing unit, a memory, and an input/output circuit that facilitates communication internal and external to the electronic controller 46. The processors, for example, may control operation of the electronic controller 46 by executing operating instructions, such as, for example, computer readable program code stored in a memory, wherein operations may be initiated internally or externally to the electronic controller 46.

Control schemes may be utilized that monitor outputs of systems or devices, such as, for example, sensors, actuators, or control units, via the input/output circuit to control inputs to various other systems or devices. Memory, as used herein, may comprise temporary storage areas, such as, for example, cache, virtual memory, or random access memory, or permanent storage areas, such as, for example, read-only memory, removable drives, network/internet storage, hard drives, flash memory, memory sticks, or any other known volatile or non-volatile data storage devices. One skilled in the art will appreciate that any computer based system or device utilizing similar components for controlling the machine systems or components described herein, is suitable for use with the present disclosure.

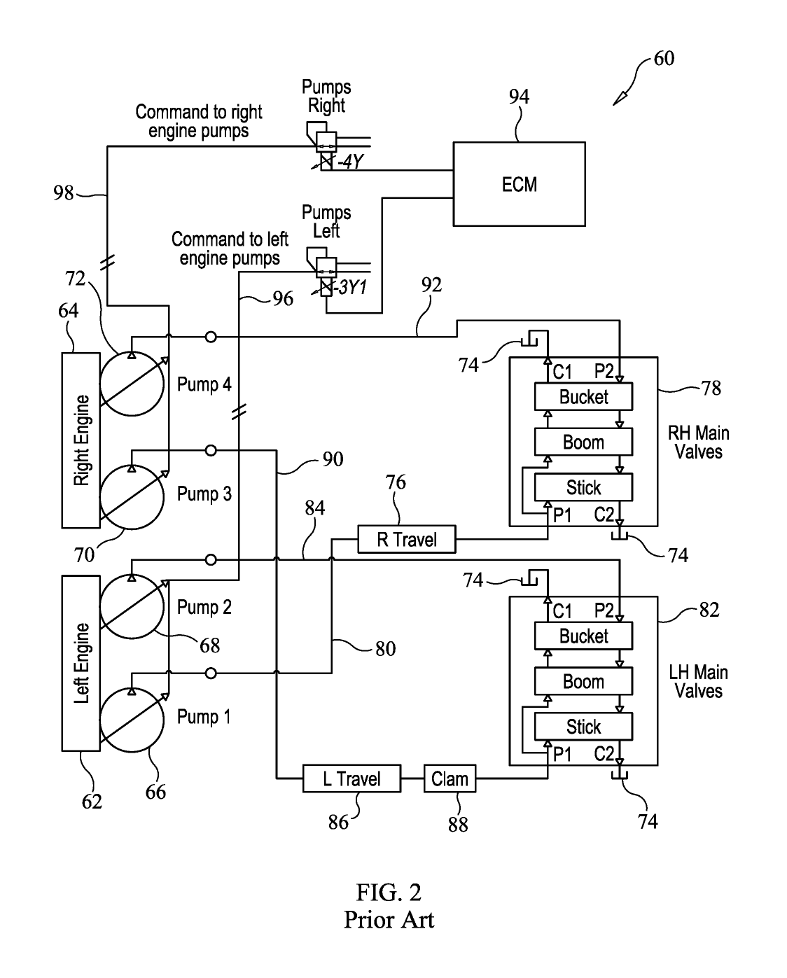

Referring now to FIG. 2, a prior art hydraulic system for use with the hydraulic excavator 10 is shown generally at 60. According to the prior art example, the hydraulic system 60 may include two engines 62, 64, with each of the engines 62, 64 providing mechanical power to two of pumps 66, 68, 70, 72. Each of the pumps 66, 68, 70, 72 may draw hydraulic fluid from a reservoir, tank or sump 74. Pump one 66 may be configured to supply hydraulic fluid to a right-hand travel motor valve 76, which provides hydraulic fluid to a right-hand travel motor, and a right-hand control valve block 78, which provides hydraulic fluid to at least one of a bucket valve, boom valve, and stick valve having circuits fluidly connected to corresponding actuators, along at least a first circuit 80. Pump two 68 may supply hydraulic fluid to a left-hand control valve block 82, which provides hydraulic fluid to at least one of a bucket valve, boom valve, and stick valve having circuits fluidly connected to corresponding actuators, along at least a second circuit 84.

Pump three 70 may supply hydraulic fluid to a left-hand travel motor valve 86, which provides hydraulic fluid to a left-hand travel motor, one or more bucket clam cylinder valves 88, which provide hydraulic fluid to corresponding actuators, and the left-hand control valve block 82 along at least a third circuit 90. The fourth pump 72 may supply hydraulic fluid to the right-hand control valve block 78 along at least a fourth circuit 92. According to this prior art embodiment, the left engine 62 powers pump one 66 and pump two 68, while the right engine 64 powers pump three 70 and pump four 72.

An electronic controller 94 provides electronic signals 96, 98 to pumps 66, 68, 70, 72 and valves 76, 78, 82, 86, 88, such as electronic control valves, to set a pump flow rate and valve displacement proportional to an operator input command. According to the prior art example, all four pumps 66, 68, 70, 72 receive the same flow command when both engines 62, 64 are running. So, for example, if the operator steps on a clam pedal, all four pumps 66, 68, 70, 72 may increase flow rate, even though only pump three 70 is actually connected to one or more clam cylinders via one or more valves 88. Similarly, all four pumps 66, 68, 70, 72 may increase flow rate when only the travel motors, receiving hydraulic fluid from valves 76 and 86 require hydraulic flow.

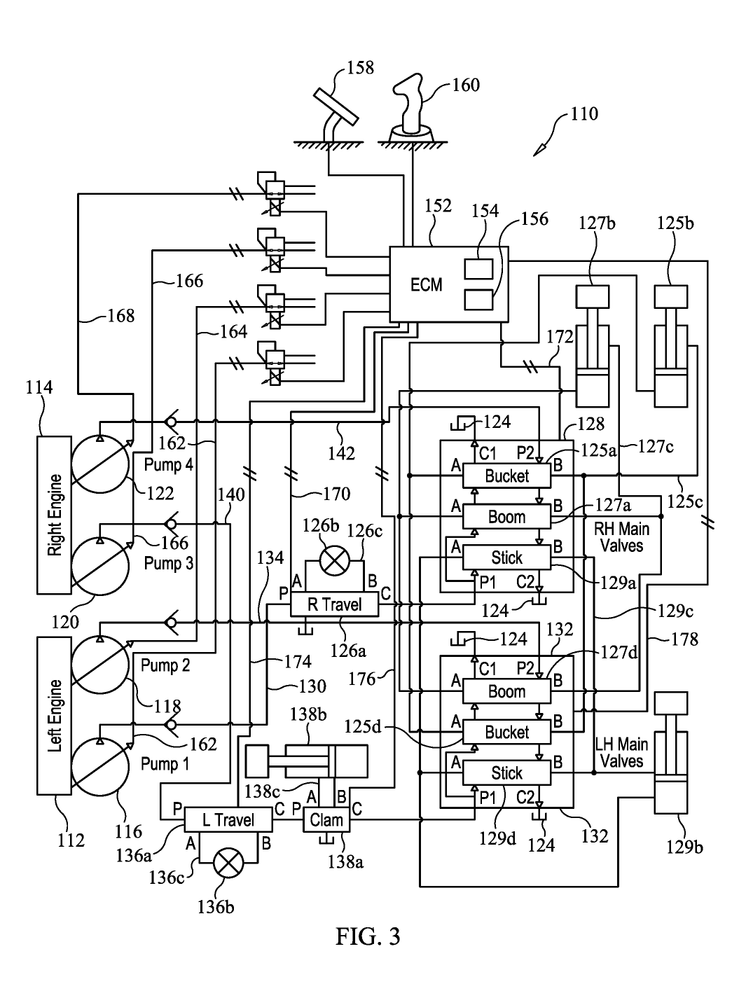

Turning now to FIG. 3, a hydraulic system according to the present disclosure is shown at 110. The exemplary hydraulic system 110 includes two engines 112, 114, such as, for example, internal combustion engines, with each engine 112, 114 providing mechanical power to two of pumps 116, 118, 120, 122. Each of the pumps 116, 118, 120, 122 may be variable displacement pumps, and may draw hydraulic fluid from a reservoir, tank or sump 124 and supply circuits 125c, 126c, 127c, 129c, 130, 134, 136c, 138c, 140, 142 with hydraulic fluid.

Pump one 116 may be configured to supply hydraulic fluid to a right-hand travel motor valve 126a, fluidly connected to right-hand travel motor 126b via circuit 126c, and a right-hand control valve block 128 along at least a first circuit 130. Right-hand control valve block 128 may include: a right-hand bucket valve 125a, fluidly connected to a bucket cylinder 125b, or one side or port of bucket cylinder 125b via circuit 125c; a right-hand boom valve 127a, fluidly connected to a boom cylinder 127b via circuit 127c; and a right-hand stick valve 129a, fluidly connected to a stick cylinder 129b via circuit 129c.

Pump two 118 may supply hydraulic fluid to a left-hand control valve block 132 along at least a second circuit 134. Left-hand control valve block 128 may include: a left-hand bucket valve 125d, or side or port thereof, fluidly connected to the bucket cylinder 125b via circuit 125c; a left-hand boom valve 127d, fluidly connected to the boom cylinder 127b via circuit 127c; and a left-hand stick valve 129d, fluidly connected to the stick cylinder 129b via circuit 129c.

Pump three 120 may supply pressurized hydraulic fluid to a left-hand travel motor valve 136a, fluidly connected to left-hand travel motor 136b via circuit 136c, a bucket clam cylinder valve 138a, fluidly connected to a bucket claim cylinder 138b via circuit 138c, and the left-hand control valve block 132 along a third circuit 140. The fourth pump 122 may supply hydraulic fluid to the right-hand control valve block 128 along a fourth circuit 142.

According to this embodiment, the left engine 112 powers pump one 116 and pump two 118, while the second engine 114 powers pump three 120 and pump four 122. It should be appreciated that a different number of pumps 116, 118, 120, 122 and a different number of circuits 125c, 126c, 127c, 129c, 130, 134, 136c, 138c, 140, 142 may be utilized in accordance to the strategy provided herein.

Control valves, such as electronic control valves, 126a, 125a, 125d, 127a, 127d, 129a, 129d, 136a, 138a may regulate hydraulic flow between the pumps 116, 118, 120, 122 and the various circuits 125c, 126c, 127c, 129c, 130, 134, 136c, 138c, 140, 142 in a known manner. For example, some or all of control valves 126a, 125a, 125d, 127a, 127d, 129a, 129d, 136a, 138a may be open center valves and may be configured to supply hydraulic fluid to a first circuit, for example, receive return hydraulic fluid from the first circuit, supply hydraulic fluid to a different circuit, bypassing the first circuit, and/or dividing, or sharing, hydraulic fluid between the first circuit and the different circuit. An exemplary hydraulic system for use with the present strategy is taught in commonly owned European Patent Application No. EP 2746466 to Cugati et al., which is hereby incorporated by reference.

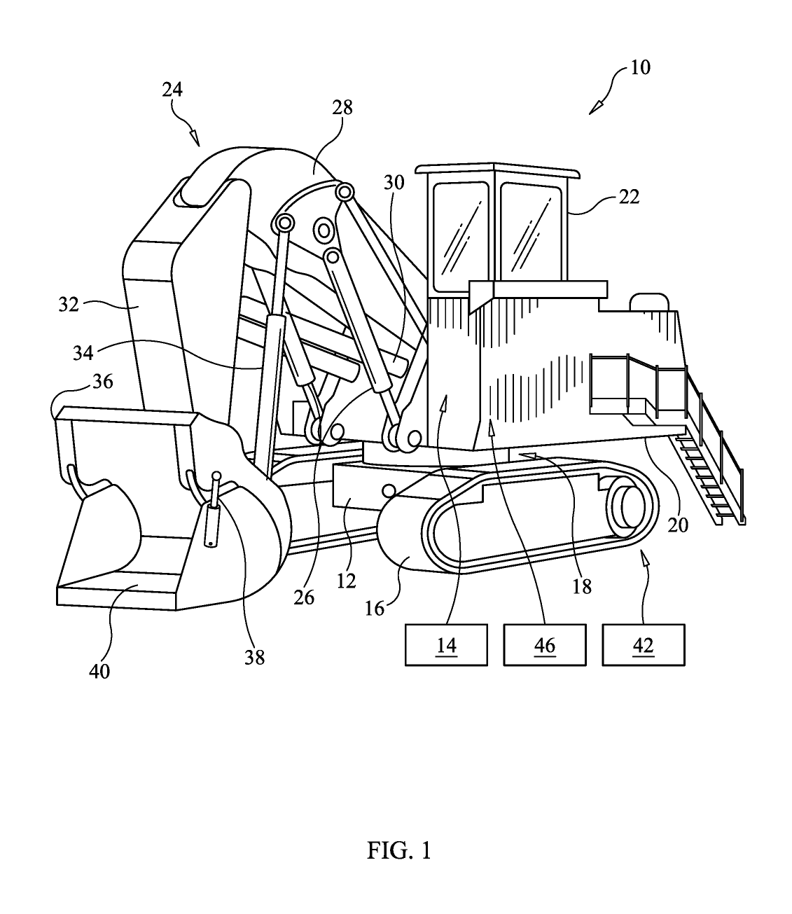

An electronic controller 152, which may include a processor 154 and a memory 156, and may be similar to the electronic controller 46 described above with reference to FIG. 1, may be in communication with pumps 116, 118, 120, 122 and electronic control valves 126a, 125a, 125d, 127a, 127d, 129a, 129d, 136a, 138a to control hydraulic flow to the various actuators 125b, 127b, 129b, 138b and motors 126b, 136b. Hydraulic flow may be controlled, at least in part, by receipt of signals received from operator control devices, such as, for example, a pedal 158 and a joystick 160, which may be located in the operator control station 22, shown in FIG. 1, and also pressure sensors located at various locations in the circuit (e.g., at pumps, cylinder head-end and rod-end).

The electronic controller 152 may include a hydraulic flow control module or algorithm, such as a set of operating instructions stored in memory 156, for controlling hydraulic flow of the hydraulic system 110. The electronic controller 152, based on the hydraulic flow control module, may be configured to generate and/or transmit electronic control signals 162, 164, 166, 168 to respective pumps 116, 118, 120, 122, and electronic control signals 170, 172, 174, 176, 178 to respective electronic control valves 126a, 125a, 125d, 127a, 127d, 129a, 129d, 136a, 138a to control the same. It should be appreciated that the electronic controller 152 may send separate signals, or similar signals, to each of the valves in control valve blocks 128, 132. Control signals 172 and 178 will each be a combination of individual boom, stick and bucket control valve signals.

According to the present disclosure, each pump 116, 118, 120, 122 may get an independent command, or command signal, 162, 164, 166, 168, and/or each electronic control valve 126a, 125a, 125d, 127a, 127d, 129a, 129d, 136a, 138a may get a separate command, or command signal, 170, 172, 174, 176, 178. During operation, at least one hydraulic component 125b, 127b, 129b, 138b, 126b, 136b may receive hydraulic flow exclusively from a designated one of the hydraulic pumps 116, 118, 120, 122 and at least another, different hydraulic component 125b, 127b, 129b, 138b, 126b, 136b may receive shared hydraulic flow from a flow sharing set of the hydraulic pumps 116, 118, 120, 122, the set of which may exclude the pump providing exclusive flow. Further, the electronic controller 152 may determine or receive information regarding a work cycle segment or task of the machine 10, which may be based on signals received from operator control devices, such as, for example, 158, 160. The current work cycle segment or task may be used by the electronic controller 152 to determine how to control the hydraulic flow.

For example, when an operator requests propulsion, such as by actuating the pedal 158 or joystick 160, pump one 116 and pump three 120 may be exclusively activated, or stroked, to provide the requested flow. That is, during a travel work cycle segment of the machine 10, the relevant pumps (e.g., pump one 116 and pump three 120) are independently activated, as opposed to controlling multiple pumps together or in pairs, regardless of the task being performed.

Likewise, when affecting movement of the clam cylinder 138, such as by actuating the pedal 158, joystick 160, or other operator control device, pump three 120 may be independently activated, or stroked, to provide the desired flow. This may occur during a dumping work cycle segment of the machine 10. Thus, exclusive and desired hydraulic flow may be provided from the relevant pump, pump three 120, exclusively to the clam actuator 138. The remaining pumps 116, 118, 122 and control valves 126a, 125a, 125d, 127a, 127d, 129a, 129d, 136a, 138a may continue to work with pump flow shared between functions. According to the exemplary embodiment, exclusive flow and shared flow, supplying hydraulic fluid to different circuits 125c, 126c, 127c, 129c, 130, 134, 136c, 138c, 140, 142, may occur simultaneously.

### INDUSTRIAL APPLICABILITY

The present disclosure relates generally to providing hydraulic power to a plurality of hydraulic circuits of a machine. One exemplary machine suited to this disclosure is a hydraulic excavator. However, the systems and methods described herein can be adapted to a large variety of machines and tasks.

Referring generally to FIGS. 1-3 and, more specifically, to FIG. 1, an exemplary hydraulic excavator 10 may generally include a machine frame 12 supporting at least one engine 14. The engine 14 may produce mechanical power that may be used by one or more machine systems or components, also supported on the machine frame 12. For example, the engine 14 may power a hydraulic system 24, which produces pressurized hydraulic fluid to power a propulsion system, which may include a tracked undercarriage 16, and/or an implement or tool of the machine 10, including boom 28, stick 32, bucket 36 and/or bucket clam 40. In particular, and according to the exemplary embodiment, the hydraulic system 24 may power hydraulic actuators 125b, 127b, 129b, 138b and motors 126b, 136b of the exemplary implement and hydraulic motors 126b, 136b powering the tracked undercarriage 16.

With specific reference to FIG. 3, a hydraulic system 110 of the present disclosure is configured such that independent electronic control signals 162, 164, 166, 168 to respective pumps 116, 118, 120, 122 and/or independent electronic control signals 170, 172, 174, 176, 178 to respective electronic control valves 126a, 125a, 125d, 127a, 127d, 129a, 129d, 136a, 138a for controlling positions of the same are utilized so that only relevant ones of pumps 116, 118, 120, 122 are stroked during certain tasks or work cycle segments. For example, the pumps 116, 118, 120, 122 may supply only the hydraulic flow that is needed for specific tasks.

In particular, for example, when an operator requests propulsion, such as by actuating the pedal 158 or joystick 160, pump one 116 and pump three 120 may be exclusively activated, or stroked. That is, during a travel work cycle segment of the machine 10, the relevant pumps 116, 120 may be independently activated, as opposed to sending the same electronic control signal to all of the pumps 116, 118, 120, 122. Likewise, when affecting movement of the clam cylinder 138b, such as by actuating the pedal 158, joystick 160, or other operator control device, pump three 140 may be independently activated to provide the needed hydraulic flow, rather than stroking all four pumps 116, 118, 120, 122, which would result in more fuel consumption than necessary. Shared flow with regard to some hydraulic circuits 125c, 126c, 127c, 129c, 130, 134, 136c, 138c, 140, 142 and exclusive flow with regard to one or more different circuits may occur simultaneously.

The present disclosure is directed to the combination of exclusive hydraulic flow and shared hydraulic flow in a machine having a hydraulic system utilizing multiple hydraulic pumps and hydraulic circuits. The strategy results in significant cost savings, including fuel cost savings.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A hydraulic system for a machine, including:
a plurality of hydraulic components, wherein the hydraulic components include hydraulic actuators and hydraulic motors;
a plurality of hydraulic circuits; and
a plurality of hydraulic pumps for supplying hydraulic fluid to the plurality of hydraulic components via the hydraulic circuits;
wherein at least one hydraulic component receives hydraulic flow exclusively from a designated one of the hydraulic pumps and at least another, different hydraulic component receives shared hydraulic flow from a flow sharing set of the hydraulic pumps.

2. The hydraulic system of claim 1, further including a plurality of electronic control valves regulating hydraulic flow between the hydraulic pumps and the hydraulic components.

3. The hydraulic system of claim 1, wherein the flow sharing set of the hydraulic pumps excludes the designated one of the hydraulic pumps.

4. The hydraulic system of claim 1, wherein a travel motor receives hydraulic flow exclusively from the designated one of the hydraulic pumps.

5. The hydraulic system of claim 4, wherein the travel motor receives hydraulic flow exclusively from the designated one of the hydraulic pumps during a travel work cycle segment of the machine.

6. The hydraulic system of claim 1, wherein a hydraulic actuator receives hydraulic flow exclusively from the designated one of the hydraulic pumps.

7. The hydraulic system of claim 6, wherein a clam actuator receives hydraulic flow exclusively from the designated one of the hydraulic pumps.

8. The hydraulic system of claim 7, wherein the clam actuator receives hydraulic flow exclusively from the designated one of the hydraulic pumps during a dumping work cycle segment of the machine.

9. The hydraulic system of claim 1, wherein a boom actuator, a stick actuator, and a bucket actuator receive shared hydraulic flow from the flow sharing set of hydraulic pumps.

10. The hydraulic system of claim 9, wherein the boom actuator, the stick actuator, and the bucket actuator receive shared hydraulic flow from the flow sharing set of hydraulic pumps during a dumping work cycle segment.

11. The hydraulic system of claim 1, further including an electronic controller providing independent pump control commands to each of the hydraulic pumps.

12. A hydraulic excavator, including:
a machine frame supporting a hydraulic system;
the hydraulic system including:
a plurality of hydraulic components, wherein the hydraulic components include hydraulic actuators and hydraulic motors;
a plurality of hydraulic circuits;
a plurality of hydraulic pumps for supplying hydraulic fluid to the plurality of hydraulic components via the hydraulic circuits; and
an electronic controller providing independent pump control commands to each of the hydraulic pumps such that at least one hydraulic component receives hydraulic flow exclusively from a designated one of the hydraulic pumps and at least another, different hydraulic component receives shared hydraulic flow from a flow sharing set of the hydraulic pumps.

13. The hydraulic excavator of claim 12, wherein a travel motor receives hydraulic flow exclusively from the designated one of the hydraulic pumps.

14. The hydraulic excavator of claim 12, wherein a hydraulic actuator receives hydraulic flow exclusively from the designated one of the hydraulic pumps.

15. The hydraulic excavator of claim 12, wherein a boom actuator, a stick actuator, and a bucket actuator receive shared hydraulic flow from the flow sharing set of hydraulic pumps.

16. A method of controlling hydraulic flow for a hydraulic system of a machine, the method including steps of:
circulating hydraulic fluid from a plurality of hydraulic pumps to a plurality of hydraulic components, wherein the hydraulic components include hydraulic actuators and hydraulic motors, via a plurality of hydraulic circuits;
providing hydraulic flow to at least one hydraulic component exclusively from a designated one of the hydraulic pumps; and
providing shared hydraulic flow to at least another, different hydraulic component from a flow sharing set of the hydraulic pumps.

17. The method of claim 16, further including providing hydraulic flow to a travel motor exclusively from the designated one of the hydraulic pumps.

18. The method of claim 16, further including providing hydraulic flow to a hydraulic actuator exclusively from the designated one of the hydraulic pumps.

19. The method of claim 18, further including providing hydraulic flow exclusively to a clam actuator from the designated one of the hydraulic pumps.

20. The method of claim 16, further including providing shared hydraulic flow to a boom actuator, a stick actuator, and a bucket actuator from the flow sharing set of the hydraulic pumps.
